(19) United States
(12) Patent Application Publication
(10) Pub. No.: US 2025/0139834 A1
(43) Pub. Date: May 1, 2025

(54) SCALABLE FRAMEWORK FOR POINT CLOUD COMPRESSION

(71) Applicant: InterDigital VC Holdings, Inc., Wilmington, DE (US)

(72) Inventors: Jiahao PANG, New York, NY (US); Muhammad Asad LODHI, New York, NY (US); Dong TIAN, Wilmington, DE (US)

(21) Appl. No.: 18/727,260

(22) PCT Filed: Dec. 14, 2022
(86) PCT No.: PCT/US2022/052861

§ 371 Date: Jul. 8, 2024

Related U.S. Application Data
(60) Provisional application No. 63/388,087, filed on Jul. 11, 2022.
(60) Provisional application No. 63/297,869, filed on Jan. 10, 2022.

(51) Int. Cl. G06T 9/00

(52) U.S. Cl. CPC G06T 9/001; G06T 9/002

(57) ABSTRACT

In one implementation, we propose a lossy point cloud compression scheme to encode point cloud geometry with deep neural networks. The encoder first encodes a coarser version of the input point cloud as a bitstream. Then it represents the residual (fine geometry details) of the input point cloud as pointwise features of the encoded coarser point cloud, followed by encoding the features as the second bitstream. On the decoder side, the coarser point cloud is firstly decoded from the first bitstream. Then its pointwise features are decoded. In the end, the residual is decoded from the pointwise features and added back to the coarser point cloud, leading to a high-quality decoded point cloud. The encoding and/or decoding of the features can be further augmented with feature aggregation, such as transformer blocks.

### TECHNICAL FIELD

The present embodiments generally relate to a method and an apparatus for point cloud compression and processing.

### BACKGROUND

The Point Cloud (PC) data format is a universal data format across several business domains, e.g., from autonomous driving, robotics, augmented reality/virtual reality (AR/VR), civil engineering, computer graphics, to the animation/movie industry. 3D LiDAR (Light Detection and Ranging) sensors have been deployed in self-driving cars, and affordable LiDAR sensors are released from Velodyne Velabit, Apple ipad Pro 2020 and Intel RealSense LiDAR camera L515. With advances in sensing technologies, 3D point cloud data becomes more practical than ever and is expected to be an ultimate enabler in the applications discussed herein.

### SUMMARY

According to an embodiment, a method of decoding point cloud data is presented, comprising: decoding a first version of a point cloud; obtaining a pointwise feature set for said first version of said point cloud; obtaining refinement information for said first version of said point cloud from said pointwise feature set; and obtaining a second version of said point cloud, based on said refinement information and said first version of said point cloud.

According to another embodiment, a method of encoding point cloud data is presented, comprising: encoding a first version of a point cloud; reconstructing a second version of said point cloud for said point cloud; obtaining refinement information based on said second version of said point cloud and said point cloud; obtaining a pointwise feature set for said second version of said point cloud from said refinement information; and encoding said pointwise feature set.

According to another embodiment, an apparatus for decoding point cloud data is presented, comprising one or more processors and at least one memory coupled to said one or more processors, wherein said one or more processors are configured to decode a first version of a point cloud; obtain a pointwise feature set for said first version of said point cloud; obtain refinement information for said first version of said point cloud from said pointwise feature set; and obtain a second version of said point cloud, based on said refinement information and said first version of said point cloud.

According to another embodiment, an apparatus for encoding point cloud data is presented, comprising one or more processors and at least one memory coupled to said one or more processors, wherein said one or more processors are configured to encode a first version of a point cloud; reconstruct a second version of said point cloud for said point cloud; obtain refinement information based on said second version of said point cloud and said point cloud; obtain a pointwise feature set for said second version of said point cloud from said refinement information; and encode said pointwise feature set.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for encoding or decoding point cloud data according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2A, FIG. 2B, FIG. 2C and FIG. 2D illustrate point-based, octree-based, voxel-based, and sparse voxel-based point cloud representations, respectively.

FIG. 3 illustrates an encoder architecture, according to an embodiment.

FIG. 4 illustrates a decoder architecture, according to an embodiment.

FIG. 5 illustrates an encoder architecture with lossless base codec, according to an embodiment.

FIG. 6 is a diagram of the subtraction module, according to an embodiment.

FIG. 7 is a diagram of the residual-to-feature converter, according to an embodiment.

FIG. 8 is a diagram of the residual-to-feature converter for sparse point clouds, according to an embodiment.

FIG. 9 illustrates a feature encoder architecture, according to an embodiment.

FIG. 10 illustrates a feature decoder architecture, according to an embodiment.

FIG. 11 illustrates an example of applying sparse tensor operations, according to an embodiment.

FIG. 12 is a diagram of the feature-to-residual converter, according to an embodiment.

FIG. 13 is a diagram of the summation module, according to an embodiment.

FIG. 14 is a decoder architecture in the skip mode, according to an embodiment.

FIG. 15 is a feature decoder architecture in the skip mode, according to an embodiment.

FIG. 16 illustrates another feature encoder architecture, according to an embodiment.

FIG. 17 illustrates a feature decoder architecture, according to an embodiment.

FIG. 18 illustrates cascading of several feature aggregation modules, according to an embodiment.

FIG. 19 illustrates a transformer block for feature aggregation.

FIG. 20 illustrates an Inception-ResNet block for feature aggregation.

FIG. 21 illustrates a ResNet block for feature aggregation.

### DETAILED DESCRIPTION

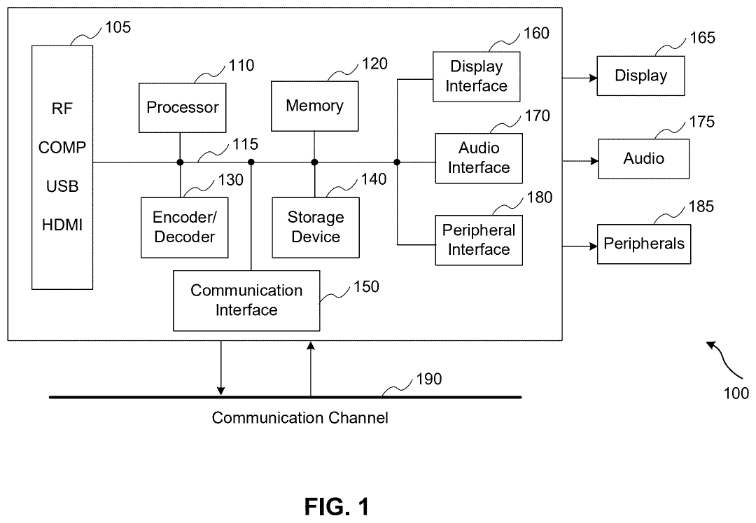

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, JPEG Pleno, MPEG-I, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

It is contemplated that point cloud data may consume a large portion of network traffic, e.g., among connected cars over 5G network, and immersive communications (VR/AR). Efficient representation formats are necessary for point cloud understanding and communication. In particular, raw point cloud data need to be properly organized and processed for the purposes of world modeling and sensing. Compression on raw point clouds is essential when storage and transmission of the data are required in the related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be in real-time or with low delay.

The automotive industry and autonomous car are domains in which point clouds may be used. Autonomous cars should be able to “probe” their environment to make good driving decisions based on the reality of their immediate surroundings. Typical sensors like LiDARs produce (dynamic) point clouds that are used by the perception engine. These point clouds are not intended to be viewed by human eyes and they are typically sparse, not necessarily colored, and dynamic with a high frequency of capture. They may have other attributes like the reflectance ratio provided by the LiDAR as this attribute is indicative of the material of the sensed object and may help in making a decision.

Virtual Reality (VR) and immersive worlds are foreseen by many as the future of 2D flat video. For VR and immersive worlds, a viewer is immersed in an environment all around the viewer, as opposed to standard TV where the viewer can only look at the virtual world in front of the viewer. There are several gradations in the immersivity depending on the freedom of the viewer in the environment. Point cloud is a good format candidate to distribute VR worlds. The point cloud for use in VR may be static or dynamic and are typically of average size, for example, no more than millions of points at a time.

Point clouds may also be used for various purposes such as culture heritage/buildings in which objects like statues or buildings are scanned in 3D in order to share the spatial configuration of the object without sending or visiting the object. Also, point clouds may also be used to ensure preservation of the knowledge of the object in case the object may be destroyed, for instance, a temple by an earthquake. Such point clouds are typically static, colored, and huge.

Another use case is in topography and cartography in which using 3D representations, maps are not limited to the plane and may include the relief. Google Maps is a good example of 3D maps but uses meshes instead of point clouds. Nevertheless, point clouds may be a suitable data format for 3D maps and such point clouds are typically static, colored, and huge.

World modeling and sensing via point clouds could be a useful technology to allow machines to gain knowledge about the 3D world around them for the applications discussed herein.

3D point cloud data are essentially discrete samples on the surfaces of objects or scenes. To fully represent the real world with point samples, in practice it requires a huge number of points. For instance, a typical VR immersive scene contains millions of points, while point clouds typically contain hundreds of millions of points. Therefore, the processing of such large-scale point clouds is computationally expensive, especially for consumer devices, e.g., smartphone, tablet, and automotive navigation system, that have limited computational power.

In order to perform processing or inference on a point cloud, efficient storage methodologies are needed. To store and process an input point cloud with affordable computational cost, one solution is to down-sample the point cloud first, where the down-sampled point cloud summarizes the geometry of the input point cloud while having much fewer points. The down-sampled point cloud is then fed to the subsequent machine task for further consumption. However, further reduction in storage space can be achieved by converting the raw point cloud data (original or down-sampled) into a bitstream through entropy coding techniques for lossless compression. Better entropy models result in a smaller bitstream and hence more efficient compression. Additionally, the entropy models can also be paired with downstream tasks which allow the entropy encoder to maintain the task-specific information while compressing.

In addition to lossless coding, many scenarios seek lossy coding for significantly improved compression ratio while maintaining the induced distortion under certain quality levels.

We propose a learning-based PCC framework which can perform compression using different point cloud representations. In the follows, we first review different point cloud representations and their usage in learning-based PCC.

### Point-Based Representation

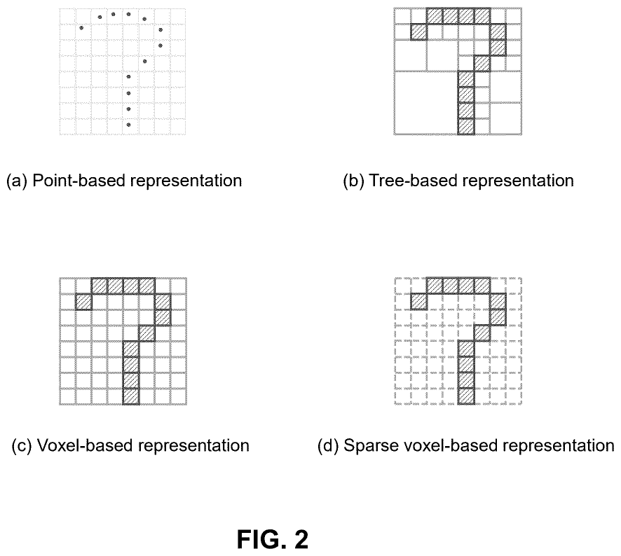

A point cloud is essentially a set of 3D coordinates that samples the surface of objects or scenes. In this native representation, each point is directly specified by its x, y, and z coordinates in the 3D space. However, the points in a point cloud are usually unorganized and sparsely distributed in the 3D space, making it difficult to directly process the point coordinates. FIG. 2A provides an example of point-based representation. For simplicity, all illustrations in FIG. 2A, FIG. 2B, FIG. 2C and FIG. 2D showcase the corresponding point cloud representations in the 2D space.

By virtue of the development of deep learning, point cloud processing and compression has also been studied with the native point-based representation. One of the most representative works in this thread is PointNet, which is a point-based processing architecture based on multi-layer perceptrons (MLP) and global max pooling operators for feature extraction. Subsequent works, such as PointNet++, DGCNN, KP-Conv, etc., extends PointNet to more complex point-based operations which count for the neighboring information. These point-based processing architectures can be utilized for PCC. In the work described in an article by Yan, Wei, et al., entitled “Deep autoencoder-based lossy geometry compression for point clouds,” arXiv preprint arXiv: 1905.03691, 2019, the encoder employs a 5-layer PointNet to extract a feature vector to compress an input point cloud. Its decoder employs a series of MLPs to decode the point cloud. In another work DECOPO (see an article by Wiesmann, Louis, et al., entitled “Deep compression for dense point cloud maps,” IEEE Robotics and Automation Letters 6, no. 2, pp. 2060-2067, 2021), KP-Conv is adopted for processing an input point cloud and generates a bit stream.

### Octree-Based Representation

Besides the native point coordinates, a point cloud can be represented via an octree decomposition tree, as shown in an example in FIG. 2B. Firstly, a root node is constructed which covers the full 3D space in a bounding box. The space is then equally split in every direction, i.e., x-, y-, and z-directions, leading to eight (8) voxels. For each voxel, if there are at least one point, the voxel is marked to be occupied, represented by a value ‘1’; otherwise, it is marked to be empty, represented by the value ‘0’. The voxel splitting then continues until a pre-specified condition is met. FIG. 2B provides a simple example, which shows a quadtree—the 2D correspondence of an octree. By encoding an octree, its associated point cloud is encoded losslessly. A popular approach to encode an octree is by encoding each occupied voxel with an 8-bit value which indicates the occupancy of its individual octant. In this way, we first encode the root voxel node by an 8-bit value. Then for each occupied voxel in the next level, we encode its 8-bit occupancy symbol, then move to the next level.

Deep entropy models refer to a category of learning-based approaches that attempt to formulate a context model using a neural network module to predict the probability distribution of the 8-bit occupancy symbols. One deep entropy model is known as OctSqueeze (see an article by Huang, Lila, et al., entitled “OctSqueeze: Octree-structured entropy model for LiDAR compression,” in Proceedings of the IEEE/CVF Conference on Computer Vision and Pattern Recognition, 2020). It utilizes ancestor nodes including a parent node, a grandparent node, etc. Three MLP-based modules are used to estimate the probability distribution of the occupancy symbol of a current octree node. Another deep entropy model is known as VoxelContextNet (see an article by Que, Zizheng, et al., entitled “VoxelContext-Net: An octree-based framework for point cloud compression,” in Proceedings of the IEEE/CVF Conference on Computer Vision and Pattern Recognition, pp. 6042-6051, 2021). Different from OctSqueeze that uses ancestor nodes, VoxelContextNet employs an approach using spatial neighbor voxels to first analyze the local surface shape then predict the probability distribution.

### Voxel-Based Representation

In a voxel-based representation, the 3D point coordinates are uniformly quantized by a quantization step. Each point corresponds to an occupied voxel with a size equal to the quantization step (FIG. 2C). Naïve voxel representation may not be efficient in memory usage due to large empty spaces. Sparse voxel representation is then introduced where the occupied voxels are arranged in a sparse tensor format for efficient storage and processing. Example of a sparse voxel representation is depicted in FIG. 2C where the empty voxels (with dotted lines) do not consume any memory or storage.

Considering that 2D convolution has been successfully employed in learning-based image 20) compression, its extension, 3D convolution, has also been studied for point cloud compression. For this purpose, point clouds need to be represented by voxels. With regular 3D convolutions, a 3D kernel is overlaid on every location specified by a stride step no matter whether the voxels are occupied or empty. To avoid computation and memory consumption by empty voxels, sparse 3D convolutions may be applied if the point cloud voxels are represented by a sparse tensor.

In the work pcc_geo_cnn_v2 (see an article by Quach, Maurice, et al., entitled “Improved deep point cloud geometry compression,” 2020 IEEE 22nd International Workshop on Multimedia Signal Processing (MMSP)), the authors propose to encode/decode a point cloud with regular 3D convolutions. To avoid large computational cost and memory consumption, another work, PCGCv2 (see an article by Wang, Jianqiang, et al., entitled “Multiscale point cloud geometry compression,” 2021 Data Compression Conference (DCC)) encodes/decodes a point cloud with sparse 3D convolution. It also employs an octree coding scheme to losslessly encode the low bit-depth portion of the input point cloud.

In this document, we propose a scalable coding framework for lossy point cloud compression with deep neural networks. In the follows, we first provide the general architecture then describe the details.

### Overview of Proposed Scalable Coding Framework

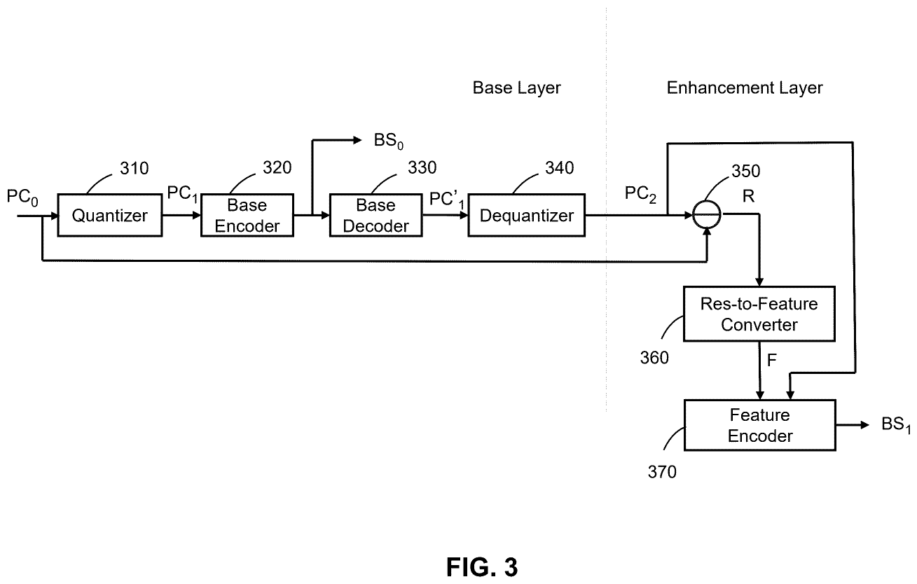

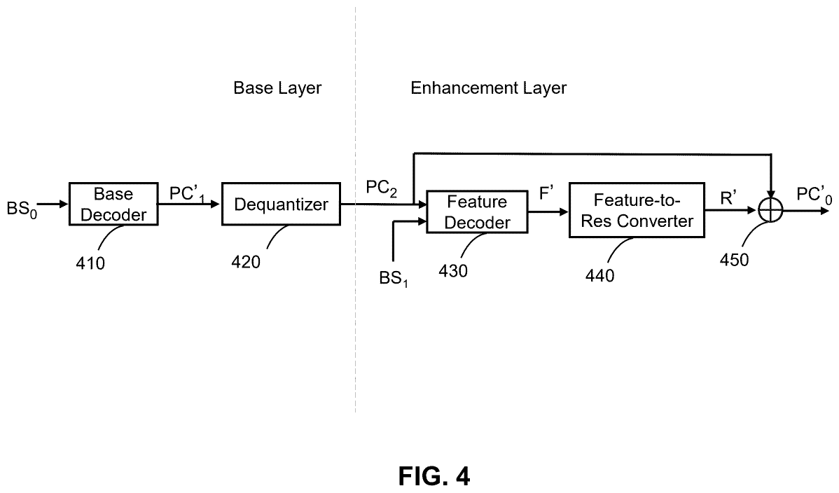

In the proposed coding framework, rather than encoding/decoding a point cloud directly, we convert the point cloud to a coarser/simplified point cloud with pointwise features as point attributes for encoding/decoding. The features represent the refinement information, for example, the residual (or geometry details) from the input point cloud. We specifically use a base layer for the encoding/decoding of the coarser point cloud, and an enhancement layer for the encoding/decoding of the pointwise features, as illustrated in FIG. 3 and FIG. 4.

Given an input point cloud PC₀ to be compressed, the encoder first converts it to a coarser point cloud. This coarser point cloud, which is easier to compress, is first encoded as a bitstream.

Then for each point in the coarser point cloud, the encoder computes a pointwise feature representing the residual (or fine geometry details of PC₀). The obtained pointwise features are further encoded as a second bitstream.

On the decoder side, we first decode the coarser point cloud from the first bitstream. Then based on the coarser point cloud, we proceed to decode a set of pointwise features from the second bitstream. Next, we reconstruct the residual component (fine details of PC₀) from the decoded features. In the end, the decoded point cloud is obtained by adding back the residual to the coarser point cloud.

### Encoding

The architecture of the encoder is provided in FIG. 3, according to an embodiment. For an input point cloud PC₀ to be compressed, it is first quantized using a quantizer (310) with a step size s (s>1). In one embodiment, for every point, say, A in PC₀ with 3D coordinates (x, y, z), the quantizer divides the coordinates by s then converts them to integers, leading to ([x/s], [y/s], [z/s]), where the function [⋅] can be the floor, ceiling or rounding function. The quantizer then removes the duplicate points with the same 3D coordinates, that is, if there exist several points having the same coordinates, we only keep one of them and remove the rest, then we get PC₁.

The obtained quantized point cloud, PC₁, is then compressed with a base point cloud encoder (320), which outputs a bitstream BS₀. Next, BS₀ is decoded with the base point cloud decoder (330) and outputs another point cloud, PC′₁. PC′₁ is then dequantized (340) with the step size s, leading to the initially reconstructed point cloud PC₂. In one embodiment, for every point, say, A in PC₀ with 3D coordinates (x, y, z), the dequantizer multiplies the coordinates by s, leading to (xs, ys, zs). We note that PC₂ is a coarser/simplified version of the original point cloud PC₀. Moreover, as the quantization step size s becomes larger, PC₂ becomes even coarser. Having obtained PC₂, the base layer is accomplished.

In the enhancement layer, we first feed PC₀ and its coarser version PC₂ to a subtraction module (350). Intuitively, the subtraction module aims to subtract PC₂ from PC₀ and outputs the residual R. The residual R contains the fine geometry details of PC₀ that is to be encoded by the enhancement layer. Next, the residual R is fed to a residual-to-feature converter (360), which generates for each point in PC₂ a pointwise feature vector. That is, a point A in PC₂ would be associated with a feature vector f_{A}, which is a high-level descriptor of the local fine details in the input PC₀ that are close to point A. Then based on PC₂, the pointwise feature set (denoted by F) will be encoded as another bitstream BS₁ with the feature encoder (370).

The two bitstreams BS₀ and BS₁ are the outputs of the encoder. They can also be merged into one unified bitstream.

### Decoding

The architecture of the decoder is provided in FIG. 4, according to an embodiment. Having received the bitstreams, BS₀ and BS₁, the base layer is first launched then proceeds to the enhancement layer. In the base layer, we first decode PC′₁ from BS₀ with the base decoder (410), then apply the dequantizer (420), with step size s, to obtain the coarser point cloud PC₂.

In the enhancement layer, a feature decoder module (430) is first applied to decode BS₁ with the already decoded coarser point cloud PC₂, which outputs a set of pointwise features F′. The feature set F′ contains the pointwise features for each point in PC₂. For instance, a point A in PC₂ has its own feature vector f′_{A}. We note that the decoded feature vector f′_{A} may have a different size from f_{A}—its corresponding feature vector on the encoder side. However, both f_{A} and f′_{A} aim to describe the local fine geometry details of PC₀ that are close to point A. The decoded feature set F′ is then passed to a feature-to-residual converter (440), which generates the residual component R′. In the end, the coarser point cloud PC₂ and the residual R′ are fed to the summation module (450). The summation module adds back the residual R′ to PC₂, leading to the final decoded point cloud, PC′₀.

### Modules

In the following, we describe the details of individual modules in the proposed framework. We also present potential variants of the modules.

### Base PCC Codec

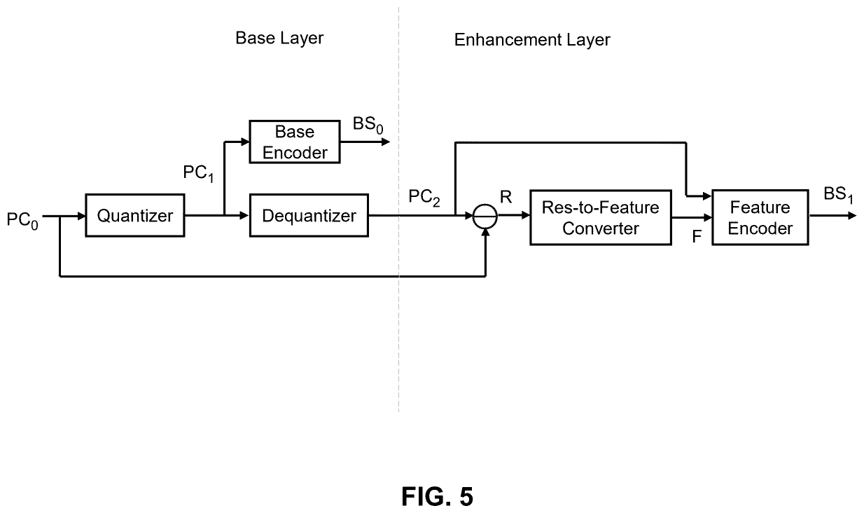

The base codec (base encoder and base decoder in FIG. 3 and FIG. 4) can be any PCC codecs. In one embodiment, the base codec is chosen to be a lossy PCC codec, such as pcc_geo_cnn_v2 and PCGCv2. In this case, PC′₁ is different from PC₁ (see FIG. 3). In another embodiment, the base codec is chosen to be a lossless PCC codec, such as the MPEG G-PCC standard, or deep entropy models with the octree representation, such as OctSqueeze and VoxelContext-Net. In this case, PC′₁ is essentially the same as PC₁. Then the encoder architecture can be simplified by removing the base decoder, as shown in FIG. 5.

### Subtraction Module

The subtraction module, i.e., “⊖” in FIG. 3, aims to subtract the coarser point cloud PC₂ from the original input point cloud PC₀, so as to obtain the residual component R. The residual R contains the geometry fine details of PC₀.

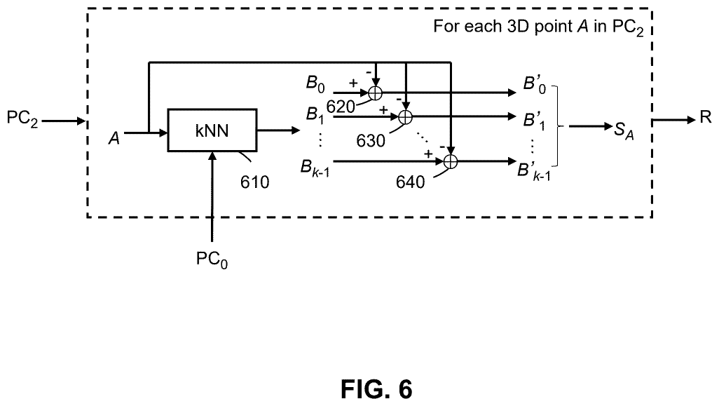

In one embodiment, the subtraction module extracts the geometry details of PC₀ via a k-nearest neighbor (kNN) search, as shown in FIG. 6. Particularly, for each 3D point A in PC₂, we search (610) for its k-nearest neighbors in PC₀. These k points are denoted as B₀, B₁, . . . , Bₖ₋₁. Then we subtract (620, 630, 640) point A from B₀, B₁, . . . , Bₖ₋₁, leading to the residual points B′₀, B′₁, . . . , B′ₖ₋₁, respectively. Note that by the term “subtract” here, we simply mean pointwise subtraction, e.g., subtracting A from B₀ is to subtract the (x, y, z) coordinates of A from (x, y, z) coordinates of B₀, respectively. We call the resulting 3D point set B′₀, B′₁, . . . , B′ₖ₋₁ the residual set of point A, denoted as S_{A}. Then suppose there are n points, A₀, A₁, . . . , Aₙ₋₁, in PC₂, their respective residual sets, denoted as S₀, S₁, . . . , Sₙ₋₁, together constitute the residual component R—the output of the subtraction module.

We note that the value of k can be chosen based on the density level of the input point cloud PC₀. For a dense point cloud, its value can be larger (e.g., k=10). On the contrary, for a sparse PC₀ such as a LiDAR sweep, the value of k can be very small, such as k=1, meaning that every point in PC₂ is only associated to one point in PC₀.

In one embodiment, instead of using the kNN search which searches for k points in PC₀ that are closest to point A, we search for all the points in PC₀ that are within a distance r from A. This operation is called the ball query. The value (or radius) r for ball query can be determined by the quantization step size s of the quantizer. For instance, given a larger s, i.e., we have a coarser PC₂, then the value of r becomes larger so as to cover more points from PC₀. In another embodiment, we still use kNN search to look for k points that are closest to a query point, say, A. However, after that, we only keep the points that are within a distance r from A. The value of r is determined in the same way as the case using ball query.

We also note that the distance metric being used by the kNN search or the ball query can be any distance metrics, such as L-1 norm, L-2 norm, and L-infinity norm.

### Residual-to-Feature Converter

With the residual component R, the residual-to-feature converter computes a set of feature vectors for the points in PC₂. Specifically, by taking a residual set (associated to a point in PC₂) as input, it generates a pointwise feature vector with a deep neural network. For instance, for a point A in PC₂, its residual set S_{A} containing 3D points B′₀, B′₁, . . . , B′ₖ₋₁ will be processed by a deep neural network, which outputs a feature vector f describing the geometry of the residual set S_{A}. For all the n points, A₀, A₁, . . . , Aₙ₋₁, in PC₂, their corresponding feature vectors, f₀, f₁, . . . , fₙ₋₁, together gives the feature set F—the output of the residual-to-feature module.

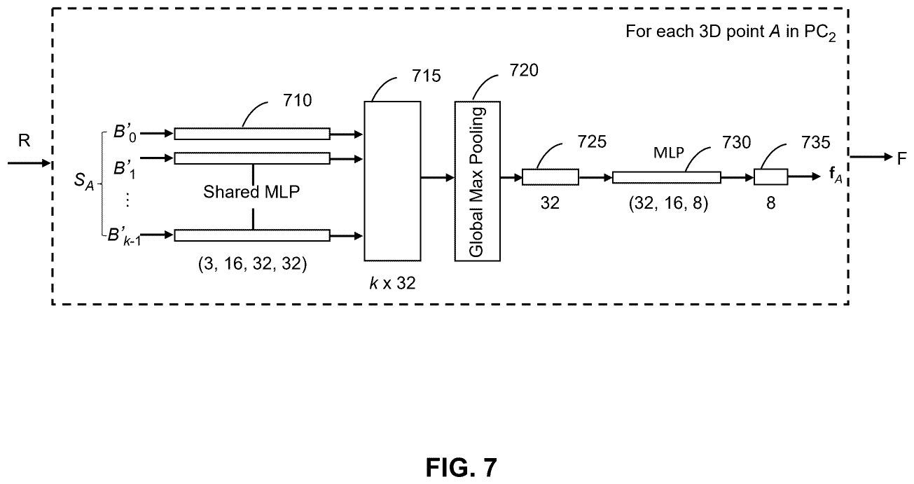

In one embodiment, the deep neural network processing Si uses a PointNet architecture, as shown in FIG. 7. It is composed of a set of shared MLPs (710). The perceptron is applied independently and in parallel on each residual point B′₀, B′₁, . . . , B′ₖ₋₁ (numbers in brackets indicate layer sizes). The output of the set of shared MLPs (715, k×32), are aggregated by the global max pooling operation (720), which extracts a global feature vector with a length 32 (725). This global feature vector is further processed by another set of MLP layers (730), leading to the output feature vector f with a length 8 (735).

In the above, a PointNet architecture is used for extracting the features. It should be noted that different network structures or configurations can be used. For example, the MLP dimensions may be adjusted according to the complexity of practical scenarios, or more sets of MLPs can be used. Generally, any network structure that meets the input/output requirements can be used.

In one embodiment, we append the number of points in the residual set S_{A} to the vector f_{A}, leading to an augmented feature vector with one additional dimension, which is to indicate the density of the set S_{A}. It is particularly useful when ball query is used in the subtraction module because the number of points retrieved by ball query can be different for different residual sets.

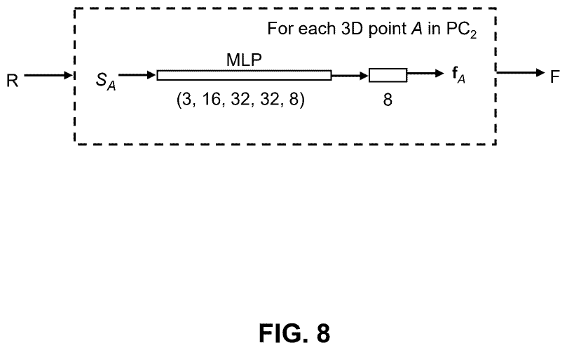

Suppose we are dealing with sparse point cloud and k=1, meaning that the residual set S_{A} itself only contains one 3D point B′₀. Then in one embodiment, the deep neural network is simplified as one set of MLP layers, as shown in FIG. 8. In another embodiment, the deep neural network is even removed, and we directly let the feature vector f_{A} be the (x, y, z) coordinates of B′₀.

### Feature Codec

The purpose of the feature codec (feature encoder and feature decoder) is to encode/decode the feature set. Specifically, it encodes the feature set F, which contains n feature vectors f₀, f₁, . . . , fₙ₋₁, to a bitstream BS₁ on the encoder side (FIG. 3), and decodes the bitstream BS₁ to the decoded feature set F′, which contains n feature vectors f′₀, f′₁, . . . , f′ₙ₋₁, on the decoder side (FIG. 4). The feature codec can be implemented based on a deep neural network.

In one embodiment, the feature encoder applies sparse 3D convolutions with downsample operators to shrink the feature set F then encode it, while the feature decoder applies sparse 3D convolutions with upsampling operators to enlarge the received feature set. This is to exploit the spatial redundancy between neighboring feature vectors to improve the compression performance. To apply sparse 3D convolutions, it is necessary to first construct a sparse 3D (or 4D) tensor representing the input point cloud. A sparse tensor only stores the occupied voxel coordinates and its associated features (e.g, FIG. 2D). A sparse 3D convolution layer only operates on the occupied voxels, so as to reduce computational cost. In the simple case where the point cloud only contains geometry (3D point coordinates), a sparse 3D tensor is constructed and a value ‘1’ is put on those occupied voxels. When the point cloud contains features/attributes in the form of 1D vectors, a sparse 4D tensor is constructed where the feature vectors are assigned to the corresponding occupied voxels.

### Feature Encoder

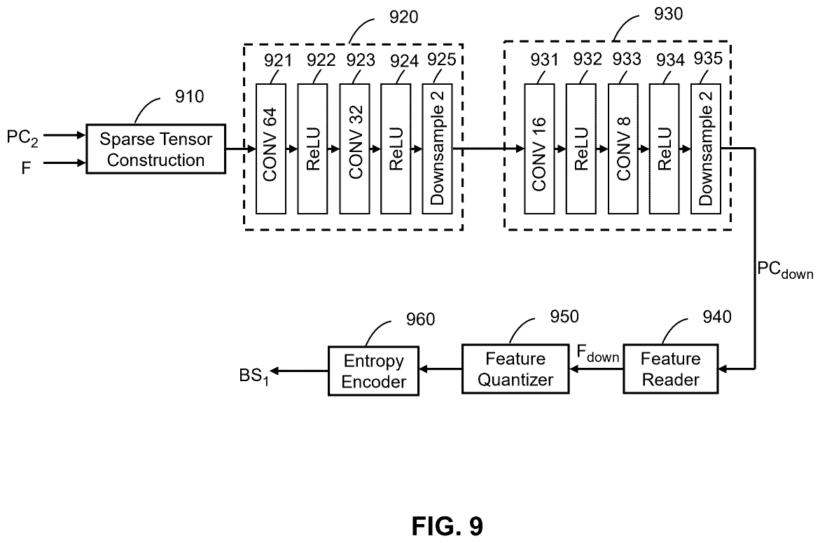

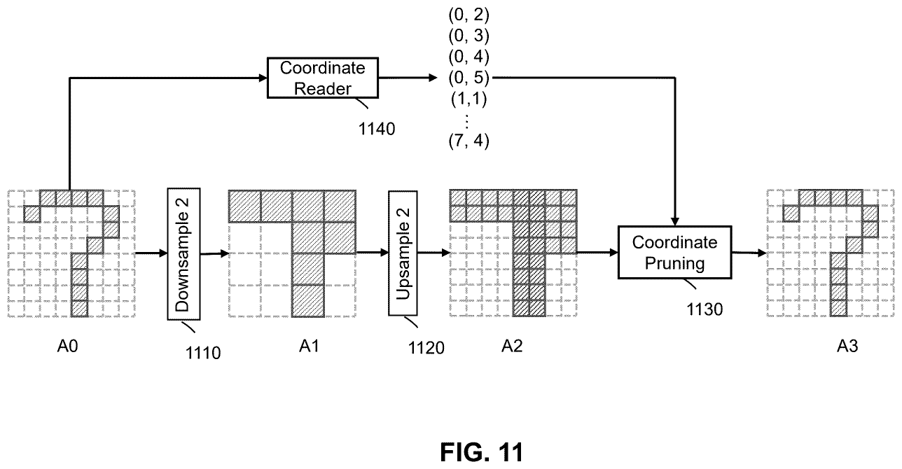

A feature encoder based on sparse 3D convolution and downsampling is shown in FIG. 9, according to an embodiment. Intuitively, we sequentially downsample the feature set F to make it smaller, then encode its downsampled version, Fdown, as a bitstream. In FIG. 9, we first construct (910) a sparse 4D tensor with PC₂ and the feature set F. We specifically let each voxel of the tensor represents a cube of size s×s×s in the 3D space, which has the same length as the quantization step size s of the quantizer/dequantizer in FIG. 3. After that, it is passed to two downsample processing blocks (920, 930), each block contains two sparse 3D convolution layers (921, 923, 931, 933) and one downsampling operator (925, 935). In FIG. 9, “CONV N” (921, 923, 931, 933) denotes a sparse 3D convolution layer with N output channels and stride 1, while “ReLU” (922, 924, 932, 934) is the ReLU non-linear activation function. The block “Downsample 2” (925, 935) is the sparse tensor downsample operator with a ratio of 2. It shrinks the size of the sparse tensor by two times along each dimension, similar to the downsample operator on regular 2D images, see FIG. 11 (1110) for an illustrative example.

The output tensor of the second processing block in FIG. 9, denoted as PC_{down}, is fed to a feature reader module (940). It reads out all the feature vectors from the occupied voxels of PC_{down}, which gives the set of downsampled features, F_{down}. It is then passed to a quantization module (950), followed by an entropy encoder (960), resulting in the output bitstream BS₁. We see that, though the target of the feature encoder is to encode the feature set F, it still needs PC₂ as input because PC₂ provides the voxel geometry for the tensor operations (e.g., convolution and downsampling) to operate.

### Feature Decoder

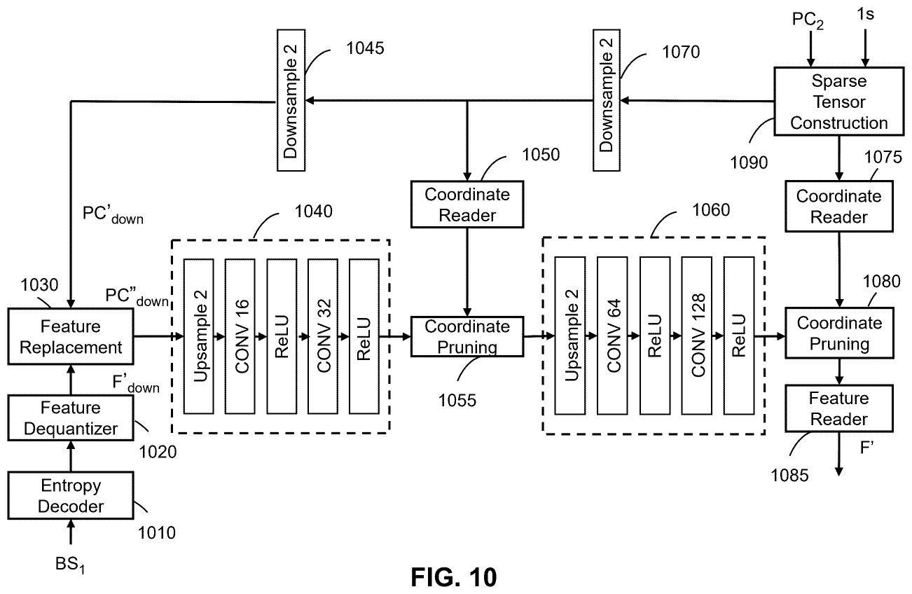

A feature decoder based on sparse 3D convolution, downsampling and upsampling is shown in FIG. 10. Intuitively, we first decode the downsampled feature set F′_{down} from the bitstream, followed by sequential upsampling using the geometry of PC₂, so as to enlarge and refine the features gradually. In FIG. 10, we first decode the bitstream BS₁ with the entropy decoder (1010), followed by a dequantizer (1020), leading to the downsampled feature set F′_{down}.

On the other hand, we also construct (1090) a 3D sparse tensor solely based on the geometry (coordinates) of PC₂, then downsample (1070, 1045) the tensor sequentially, leading to a tensor PC′_{down}. We note that PC′_{down} (in FIG. 10) and PC_{down} on the feature encoder (FIG. 9) have the same geometry, but their features are different. In order to upsample F′_{down}, we put it onto the geometry of PC′_{down}. It is accomplished by the feature replacement module (1030), which replaces the original features of PC′_{down} by F′_{down}, resulting in another sparse tensor PC″_{down}.

Next, we upsample PC″_{down} by two upsample processing blocks (1040, 1060), where each block contains one upsample operator and two sparse 3D convolution layers. In FIG. 10, “Upsample 2” is the sparse tensor upsample operator with a ratio of 2. It enlarges the size of the sparse tensor by two times along each dimension, similar to the upsample operator on regular 2D images, see FIG. 11 (1120) for an illustrative example. After each upsample processing block, the resulting tensor is refined with a coordinate pruning module (1055, 1080). FIG. 11 (1130) provides an illustrative example of coordinate pruning, which is to remove some of the occupied voxels of an input tensor and keep the rest based on a set of input coordinates, obtained from the coordinate reader (1050, 1075). Using this module, in FIG. 10 we remove some voxels (and the associated features) from the upsampled versions of PC″_{down}, and only keep those voxels that also appear in the downsampled versions of PC₂. After the second coordinate pruning module (1080), we obtain a tensor having the same geometry as PC₂, then we apply a feature reader (1085) on it to obtain the decoded feature set F′.

The entropy coder in the feature codec can be a non-learning one, it can also be an entropy coder based on deep neural networks, e.g., the factorized prior model, or the hyperprior model (see an article by Ballé, Johannes, et al., entitled “Variational image compression with a scale hyperprior,” arXiv preprint, arXiv: 1802.01436, 2018).

FIG. 9 and FIG. 10 show examples of applying two down-/up-sample processing blocks for the feature codec. However, it is possible to use fewer or more processing blocks under the same rationale. In one embodiment, one even does not apply any down-/up-sample in the feature codec. In this embodiment, the feature encoder simply applies several convolution layers in-between sparse tensor construction and the feature reader, while the feature decoder applies another set of convolutional layers in-between the feature replacement module and the feature reader. Instead of the ReLU activation function, other activation functions, such logistic sigmoid and tanh functions can also be used. The number of convolution layers, the kernel size and the number of output channels of the convolution layers, and the way to combine them can also be varied. The down-/up-sample processing blocks can also perform down-/up-sample by a ratio (denoted as α) different than 2, e.g., α=4 or α=8. In one embodiment, the downsample operator (with downsample ratio α) can be absorbed into its previous convolution layer (with stride 1), by changing the stride of the convolution layer to α. Similarly, the upsample operator (with upsample ratio α) can be absorbed into its subsequent convolution layer (with stride 1), and together they become a deconvolution layer with stride α.

FIG. 11 is used to illustrate the downsampling, upsampling, coordinate reading and coordinate pruning processes. For simplicity, the operations in FIG. 11 are illustrated in the 2D space, while the same rationale is applied for the 3D space. In this example, the input point cloud A0 occupy voxels at positions (0, 2), (0, 3), (0, 4), (0, 5), (1, 1), . . . , (7, 4). Thus, the coordinate reader (1140) outputs the occupied coordinates as (0, 2), (0, 3), (0, 4), (0, 5), (1, 1), . . . , (7, 4). By downsampling (1110) A0 by a ratio of 2, the number of voxels is reduced by half in each dimension in the downsample point cloud A1, and a voxel is considered as occupied if any of corresponding four points is occupied in A0. After upsampling (1120) A1, the number of voxels resumes in A2, and a voxel in A2 is considered as occupied if the corresponding voxel is occupied in A1. Note that now A2 is denser than the input point cloud A0. To remove/prune the points (occupied voxels) that are unoccupied in A0 from A2, the occupied coordinate information is used by the coordinate pruning module (1130). That is, in the resulting point cloud A3, only the voxels that are occupied in the original point cloud A0 is considered as occupied.

### Feature-to-Residual Converter

The feature-to-residual converter on the decoder (FIG. 4) is to convert the decoded feature set F′ back to a residual component R′. Specifically, it applies a deep neural network to convert every feature vector f′_{A} (associated with a point A in PC₂) in F′ back to its corresponding residual point set S′A.

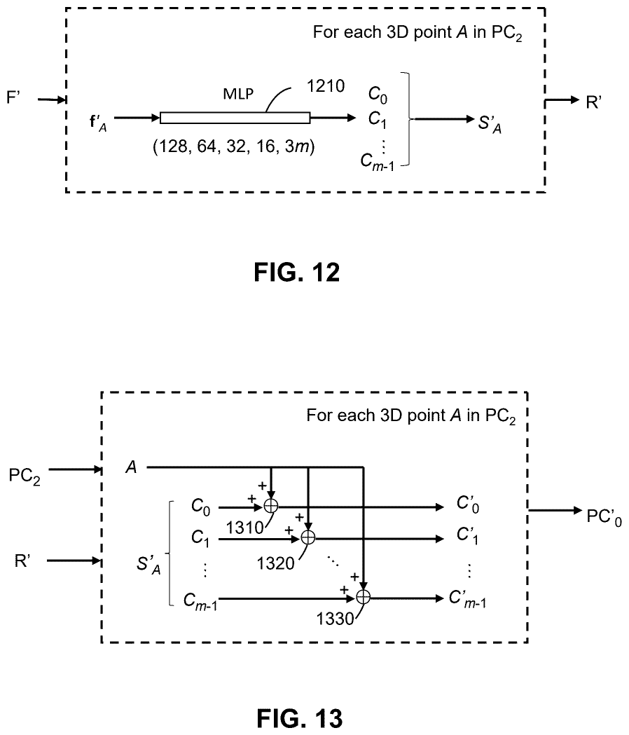

In one embodiment, we implement the feature-to-residual converter with a series of MLP layers, as shown in FIG. 12. In this case, a feature vector in F′, say, f′_{A}, is fed to a series of MLP layers (1210). The MLP layers directly output a set of m 3D points, C′₀, C′₁, . . . , C′ₘ₋₁, which gives the decoded residual set S′_{A}. Hence, for PC₂ with n points, A₀, A₁, . . . , Aₙ₋₁, the feature-to-residual converter generates their decoded residual sets, denoted as S′₀, S′₁, . . . , S′ₙ₋₁. These residual sets together constitute the decoded residual component R′.

We note that the number of decoded point m can be a fixed constant, such as m=5, or it can be adaptively chosen, such as based on the prior knowledge about the density level of PC₀. For instance, if we know PC₀ is very sparse, we can set m to be a small number, such as m=2.

In one embodiment, we also remove those 3D points in R′ that are too far away from the origin. Specifically, for a point Cₜ in R′, if its distance to the origin is larger than a threshold t, it is viewed as an outlier and removed from R′. The threshold/can be a predefined constant. It can also be chosen according to the quantization step size s of the quantizer on the encoder (FIG. 3). For instance, a larger s means PC₂ is coarser, then we also let the threshold/to be larger in order to keep more points in R′.

Instead of using simply the MLP layers, in another embodiment, the feature-to-residual converter can use more advanced architecture, such as a FoldingNet decoder (see an article by Yang, Yaoqing, et al., “FoldingNet: Point cloud auto-encoder via deep grid deformation,” Proceedings of the IEEE Conference on Computer Vision and Pattern Recognition, 2018).

### Summation Module

Having decoded the residual R′, the summation module (“⊕” in FIG. 4″) aims to add it back to the coarser point cloud PC₂ to obtain a refined decoded point cloud PC′₀.

In one embodiment, the summation module adds the points in R′ to their associated point in PC₂ and generates new 3D points, as shown in FIG. 13. For each decoded residual set S′_{A} in R′, its points, C₀, C′₁, . . . , C′ₘ₋₁, are summed up (1310, 1320, 1330) with the 3D point A respectively, resulting in another set of m points C′₀, C′₁, . . . , C″ₘ₋₁. Note that the summation in this step simply means pointwise summation, i.e., the (x, y, z) coordinates of the two 3D points are summed up, respectively. For PC₂ with n 3D points, this procedure ends up with n×m points in total, these n×m points together give the decoded point cloud PC′₀. In one embodiment, the summation module has an extra step at the end, which removes the duplicate 3D points from the obtained n×m points to get the decoded point cloud PC′₀.

### Skip Mode

In one embodiment, the decoder directly refines the coarser point cloud PC₂ without taking the bitstream BS₁ as input. The switching to the skip mode can be indicated by appending flag in BS₀, or by the supplementary enhancement information (SEI) message. We call this decoding mode the skip mode since BS₁ is skipped by the decoder. This mode is particularly useful when the bit rate budget is tight because only BS₀ is needed.

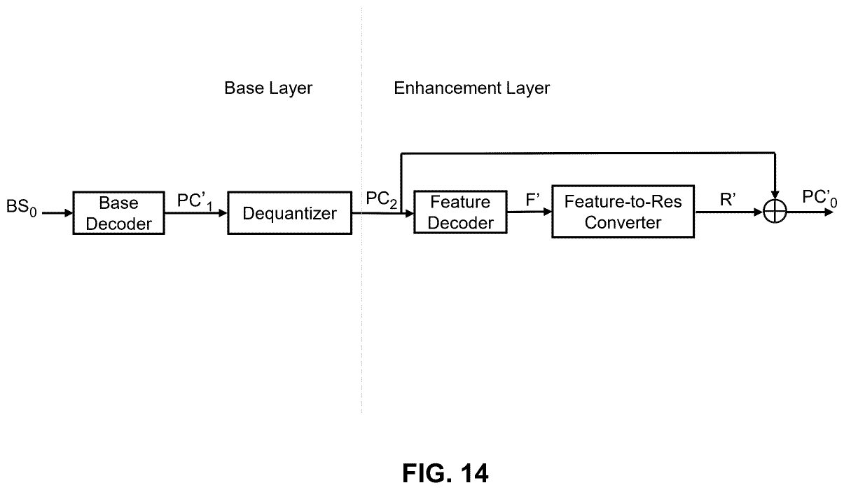

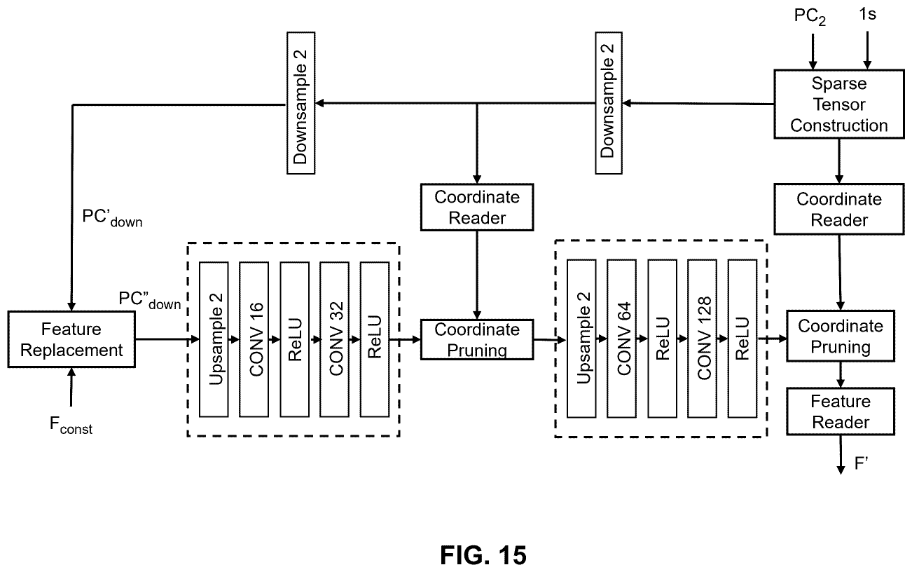

FIG. 14 shows the decoder architecture in the skip mode, in which the feature decoder only takes PC₂ as input. In this embodiment, the feature decoder generates a set of feature vectors F′ solely based on the geometry of PC₂. Under the skip mode, the architecture of the feature decoder is also simplified, as shown in FIG. 15. Note that in FIG. 15, F_{const} denotes a set of predefined, constant features, e.g., a set of features with all 1s. Different from FIG. 10, under the skip mode, the feature decoder directly replaces the features of PC′_{down} by the predefined features in F_{const} to get PC″_{down}.

### Mutiscale Coding

The previous embodiments contain two scales of granularity: the base layer deals with the coding of a coarser point cloud PC₂, and the enhancement layer deals with the coding of the fine geometry details. This two-scale coding scheme may have limitations in practice.

In one embodiment, we extend our proposal to a three-scale coding scheme. It is achieved by encapsulating our two-scale encoder (FIG. 3) and our two-scale decoder (FIG. 4) as the base encoder and the base decoder, respectively. In this case, three bitstreams, corresponding to three different scales of the input point cloud, will be generated by the codec.

With the same rationale, in another embodiment, we further extend our proposal to a coding scheme with more than three scales. It is achieved by recursively replacing the base encoder and the base decoder by our two-layer encoder (FIG. 3) and our two-layer decoder (FIG. 4).

### Simplified Feature Codec

In one embodiment, the feature codec is simplified, where the feature set F is directly entropy encoded/decoded. In this case, the feature encoder only takes the feature set F as input. Inside the feature encoder, F is directly quantized and entropy encoded as the bitstream BS₁. On the other hand, the feature decoder only takes BS₁ as input. Inside the feature decoder, BS₁ is entropy decoded, followed by dequantization, leading to the decoded feature set F′. Under the skip mode where BS₁ is not available, the enhancement layer of the decoder is skipped, and the final decoder output is the coarse point cloud PC₂.

Improvement with Feature Aggregation Modules

The features generated within the feature encoder (FIG. 9) and the feature decoder (FIG. 10) can be further aggregated/refined by introducing additional feature aggregation modules. A feature aggregation module takes a sparse tensor with features having N channels as input, then modifies its features to better serve the compression task. Note that the output features still have N channels, i.e., the feature aggregation module does not change the shape of the sparse tensor.

### Integrating the Feature Aggregation Modules

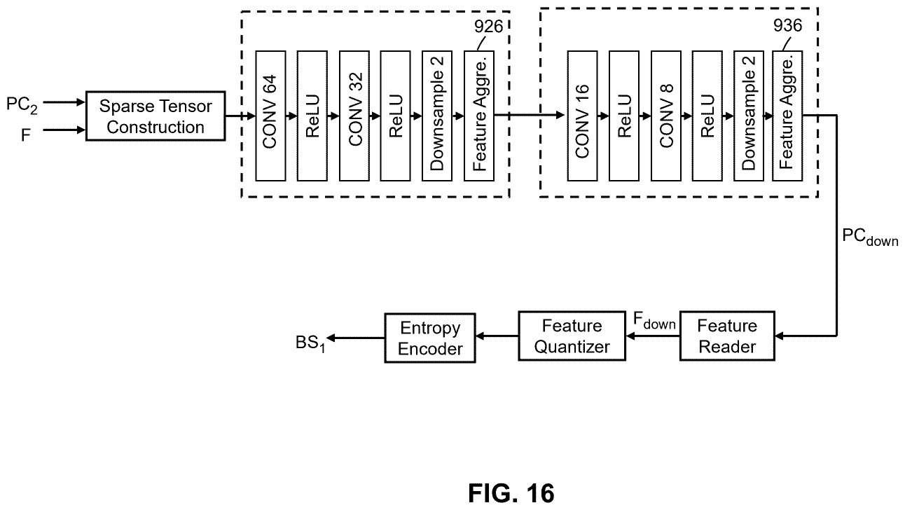

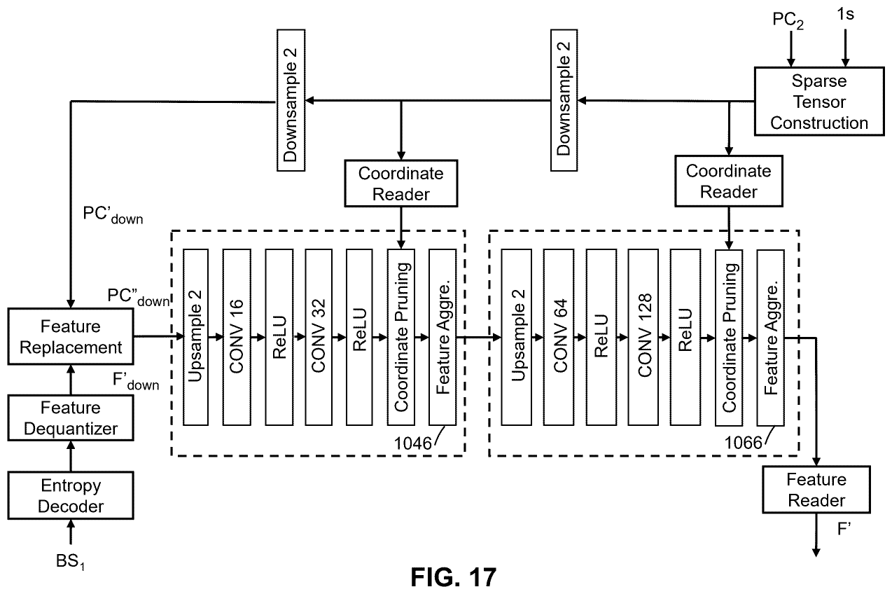

The positions to place the feature aggregation modules in the feature encoder and/or the decoder can be varied. Also, the feature aggregation modules can be only included in the encoder side, only in the decoder side, or on both encoder and decoder sides. In one embodiment, the feature encoder as shown in FIG. 9 is adjusted with a feature aggregation module (926, 936) inserted after the downsampling operator of each down-sample processing block, as shown in FIG. 16. In one embodiment, the feature decoder as shown in FIG. 10 is adjusted with a feature aggregation module (1046, 1066) inserted after each coordinate pruning operator, as shown in FIG. 17. Note that placing the feature aggregation module after (but not before) the coordinate pruning operator can lower the computational cost. Compared to FIG. 10, in FIG. 17, the coordinate pruning and the feature aggregation module are absorbed into the preceding up-sample processing block.

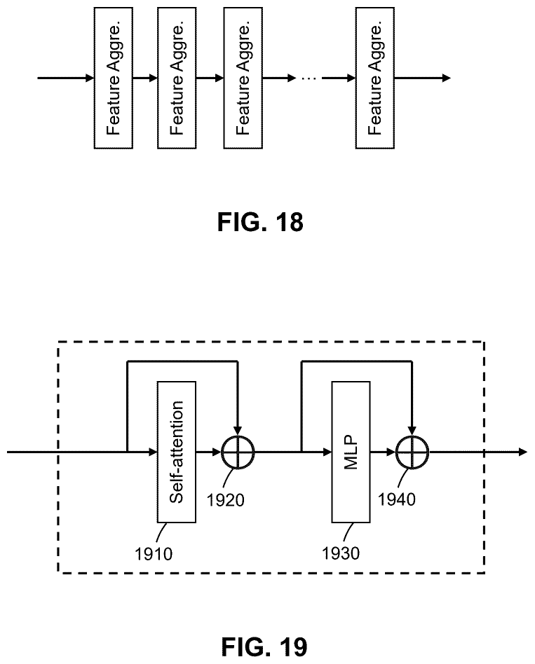

In another embodiment, instead of having just one feature aggregation module in each up-sample/down-sample processing block, several feature aggregation modules can be cascaded to achieve better compression performance, as shown in FIG. 18.

### Designs of the Feature Aggregation Module

There are different design choices of the feature aggregation module. In one embodiment, it takes a transformer architecture similar to the voxel transformer as described in an article by Mao, Jiageng, et al., “Voxel transformer for 3D object detection,” Proceedings of the IEEE/CVF International Conference on Computer Vision, 2021. The diagram of a transformer block is shown in FIG. 19, which consists of a self-attention block (1910) with residual connection (1920), and a MLP block (consisting of MLP layers, 1930) with residual connection (1940). The details of the self-attention block are described below.

Given a current feature vector f_{A} associated with a voxel location A, and its neighboring k features f_{Ai} associated with voxel locations Aᵢ, where Aᵢ (0≤i≤k−1) are the k nearest neighbors of A in the input sparse tensor, the attention block endeavors to update the feature f_{A} based on all the neighboring features f_{Ai}. Firstly, the query embedding Q_{A} for A is computed with:

Q_{A}=MLP_{Q}(f_{A}).

Then the key embedding K_{Ai} and the value embedding V_{Ai} of all the nearest neighbors of A are computed:

$${K}_{{A}_{i}} = {MLP}_{K} ( {f}_{{A}_{i}} ) + {E}_{{A}_{i}} , {V}_{{A}_{i}} = {MLP}_{V} ( {f}_{{A}_{i}} ) + {E}_{{A}_{i}} , 0 \leq i \leq k - 1 ,$$

where MLP_{Q}(⋅), MLP_{K}(⋅) and MLP_{V}(⋅) are MLP layers to obtain the query, key, and value respectively, and E_{Ai} is the positional encoding between the voxels A and Aᵢ, calculated by:

$${E}_{{A}_{i}} = {MLP}_{P} ( {P}_{A} - {P}_{{A}_{i}} ) ,$$

where MLP_{P}(⋅) is MLP layers to obtain the positional encoding, P_{A} and P_{Ai} are 3-D coordinates, they are centers of the voxels A and Aᵢ, respectively. The output feature of location A by the self-attention block is:

$${f}_{A}^{′} = {\sum }_{i = 0}^{k - 1} σ ( \frac{{Q}_{A}^{T} \cdot {K}_{{A}_{i}}}{c \sqrt{d}} ) \cdot {V}_{{A}_{i}} ,$$

where σ(⊇) is the softmax normalization function, d is the length of the feature vector f_{A} and c is a pre-defined constant.

The transformer block updates the feature for all the occupied locations in the sparse tensor in the same way, then outputs the updated sparse tensor. Note that in a simplified embodiment, MLP_{Q}(⊇), MLP_{K}(⋅), MLP_{V}(⋅), and MLP_{P}(⋅) may contain only one fully-connected layer, which corresponds to linear projections.

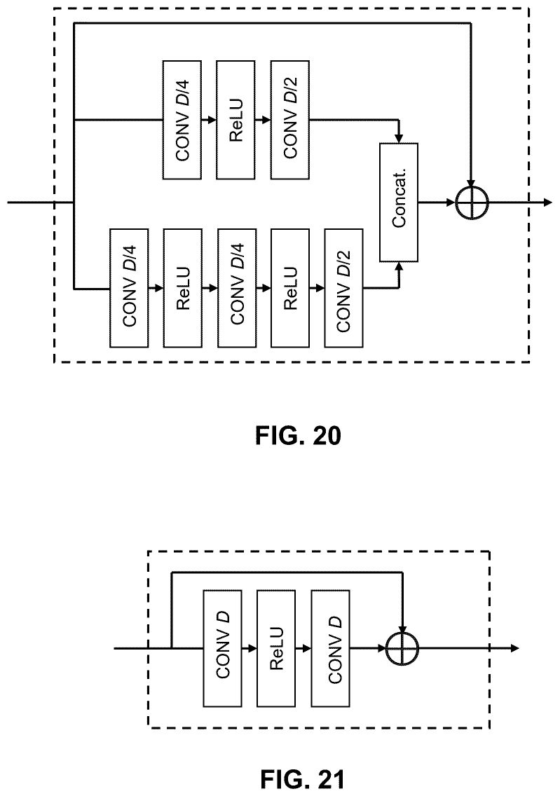

In another embodiment, the feature aggregation module takes the Inception-ResNet (IRN) architecture (see an article by Wang, Jianqiang, et al., “Multiscale point cloud geometry compression,” 2021 Data Compression Conference (DCC), IEEE, 2021), as shown in FIG. 20. In this example, it shows the architecture of an IRN block to aggregate features with D channels. Again, “CONV N” denotes a 3D convolution layer with N output channels.

In another embodiment, the feature aggregation module takes the ResNet architecture (see an article by He, Kaiming, et al., “Deep residual learning for image recognition,” Proceedings of the IEEE conference on computer vision and pattern recognition, 2016), as shown in FIG. 21. In this example, it shows the architecture of an ResNet block to aggregate features with D channels.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of decoding point cloud data, comprising:
decoding a first version of a point cloud;
obtaining a set of pointwise features for said first version of said point cloud;
obtaining refinement information for said first version of said point cloud from said set of pointwise features based on a point-based neural network; and
obtaining a second version of said point cloud, based on said refinement information and said first version of said point cloud.

2-5. (canceled)

6. The method of claim 1, further comprising:
decoding a set of point cloud data, wherein said first version of said point cloud is decoded by de-quantizing said set of point cloud data.

7. The method of claim 1, wherein said set of features are constant.

8. The method of claim 1, wherein said obtaining refinement information comprises:
converting each feature in said set of pointwise feature to one or more 3D points.

9. The method of claim 8, further comprising:
removing a point from said one or more 3D points responsive to a distance of said point from the origin.

10. The method of claim 9, wherein said distance is adaptive to a quantization step size used in dequantizing.

11-15. (canceled)

16. A method of encoding point cloud data, comprising:
encoding a first version of a point cloud;
reconstructing a second version of said point cloud;
obtaining refinement information based on said second version of said point cloud and said point cloud;
obtaining a set of pointwise features-set for said second version of said point cloud from said refinement information using a point-based neural network architecture; and
encoding said pointwise feature set.

17. The method of claim 16, wherein said refinement information corresponds to a residual component.

18. The method of claim 16, wherein said reconstructing a second version of said point cloud comprises:
dequantizing decoded first version of said point cloud to form said second version of said point cloud.

19. (canceled)

20. The method of claim 16, wherein said obtaining refinement information comprises, for a point in said second version of said point cloud:
obtaining one or more nearest neighbors in said first version of said point cloud; and
obtaining a respective difference between 3D coordinates of said point and each point of said one or more nearest neighbors.

21-35. (canceled)

36. An apparatus, comprising one or more processors and at least one memory coupled to said one or more processors, wherein said one or more processors are configured to:
decode a first version of a point cloud;
obtain a set of pointwise features set for said first version of said point cloud;
obtain refinement information for said first version of said point cloud from said set of pointwise features set, based on a point-based neural network; and
obtain a second version of said point cloud, based on said refinement information and said first version of said point cloud.

37. The apparatus of claim 36, wherein said one or more processors are further configured to:
decode a set of point cloud data, wherein said first version of said point cloud is decoded by de-quantizing said set of point cloud data.

38. The apparatus of claim 36, wherein said set of features are constant.

39. The apparatus of claim 36, wherein said one or more processors are further configured to obtain said refinement information by:
converting each feature in said set of pointwise feature to one or more 3D points.

40. The apparatus of claim 39, wherein said one or more processors are further configured to:
remove a point from said one or more 3D points responsive to a distance of said point from the origin.

41. The apparatus of claim 40, wherein said distance is adaptive to a quantization step size used in dequantizing.

42. An apparatus, comprising one or more processors and at least one memory coupled to said one or more processors, wherein said one or more processors are configured to:
encode a first version of a point cloud;
reconstruct a second version of said point cloud;
obtain refinement information based on said second version of said point cloud and said point cloud;
obtain a set of pointwise features for said second version of said point cloud from said refinement information using a point-based neural network architecture; and
encode said pointwise feature set.

43. The apparatus of claim 42, wherein said refinement information corresponds to a residual component.

44. The apparatus of claim 42, wherein said one or more processors are further configured to reconstruct a second version of said point cloud by:
dequantizing decoded first version of said point cloud to form said second version of said point cloud.

45. The apparatus of claim 42, wherein said one or more processors are further configured to obtain said refinement information by, for a point in said second version of said point cloud:
obtaining one or more nearest neighbors in said first version of said point cloud; and
obtaining a respective difference between 3D coordinates of said point and each point of said one or more nearest neighbors.
